(19) United States
(12) Patent Application Publication
(10) Pub. No.: US 2016/0074759 A1
(43) Pub. Date: Mar. 17, 2016

(54) OMNI SPINNER

(71) Applicant: LightUpToys.com LLC, Sellersburg, IN (US)

(72) Inventors: Joshua C. Kelly, Sellersburg, IN (US); Max Armendariz Lalama, Georgetown, IN (US); Christopher Kelly, New Alabany, IN (US)

(21) Appl. No.: 14/487,423

(22) Filed: Sep. 16, 2014

(51) Int. Cl. A63H 1/24; F21V 14/02; F21V 33/00; F21V 23/04; F21V 21/40

(52) U.S. Cl. CPC A63H 1/24; F21V 23/0414; F21V 23/0471; F21V 21/406; F21V 33/008; F21V 14/025

(57) ABSTRACT

A handheld electronic device that can illuminate while certain parts are spinning and is capable of producing visual patterns in space due to unique features associated with spinning action and illumination.

### PRIORITY

This application:
1. is a continuation-in-part of U.S. Nonprovisional Utility patent application Ser. No. 14/299,231 for the invention titled “HAND HELD SPINNING TOY WITH ILLUMINATED IMAGE” with a filing date of Jun. 9, 2014, which claims priority to U.S. Provisional Utility Application No. 61/822,917 for the invention titled “Hand Held Spinning Toy With Illuminated Image”;
2. claims priority to U.S. Provisional Utility Application No. 61/878,148 for the invention titled “Hand held spinning toy with illuminated object” with a filing date of Sep. 16, 2013;
3. claims priority to U.S. Provisional Utility Application No. 61/951,620 for the invention titled “HAND HELD SPINNING DEVICE WITH ILLUMINATED IMAGE” with a filing date of Mar. 12, 2014;
4. claims priority to U.S. Provisional Utility Application No. 61/899,312 for the invention titled “MEGA MAX PROVISIONAL” with a filing date of Nov. 4, 2013;
5. claims priority to U.S. Provisional Utility Application No. 61/991,556 for the invention titled “Diamond Spinner” with a filing date of May 11, 2014; and
6. claims priority to U.S. Provisional Utility Application No. 61/904,732 for the invention titled “SPINNING ACTION LIGHT-UP TOY” with a filing date of Nov. 15, 2013.

### FIELD OF THE INVENTION

The present invention is in the field of handheld electronic devices. More particularly, the present invention is in the field of handheld illuminating and spinning toys.

### BACKGROUND OF THE INVENTION

There are numerous scanning toys and appliances that rely on the spinning or vibrating action of an arm that is populated with LEDs along its length. In this manner words, numbers, and images can be displayed such as those used in some clocks. There are also toys that blink LEDs on and off to produce asynchronous patterns of light. And further, there are toys that illuminate objects with LEDs.

Embodiment No. 1 of the present invention takes advantage of illuminating a three dimensional translucent figurine or shape and simultaneously rotating LEDs that are located at the end of arms which splay outward due to the centripetal force generated by spinning. This produces a unique effect, which can appeal to a market driven by the marriage of technology and fun in a cost effective manner.

For many years there have been toys that illuminate objects, from simple flashlights to projectors of static and moving images. There has been a recent deluge of scanning toys employing one or more moving LEDs that turn on and off quickly, thus creating patterns of light that can spell words and create images.

Embodiment No. 2 of the present invention employs several unique innovations wherein a scanning incoherent light source radiates from an entire coiled cylinder of thin plastic, and this creates an illumination of a central image when rotating, and this moving illumination creates a three dimensional appearance not unlike a virtual holograph, though illuminated with incoherent light. Together with multiple coiled cylinders of thin plastic, each illuminated with a different color LED, a fascinating combination of effects can be achieved.

There has also been a recent deluge of scanning toys employing one or more moving LEDs that turn on and off quickly, thus creating patterns of light that can spell words and create images.

Embodiment No. 3 of the present invention takes advantage of illuminating a spinning translucent shell upon which an image is located, and with it are simultaneously rotating LEDs that are located at the ends of flexible elements which splay outward due to the centripetal force generated by spinning. This produces a unique effect, which can appeal to a market driven by the marriage of technology and fun in a cost effective manner.

Embodiment No. 4 of the present invention employs several unique innovations wherein a scanning incoherent light source radiates from an entire coiled cylinder of thin plastic, and this creates an illumination of a central image when rotating, and this moving illumination creates a three dimensional appearance not unlike a virtual holograph, though illuminated with incoherent light. Together with multiple coiled cylinders of thin plastic, each illuminated with a different color LED, a fascinating combination of effects can be achieved.

Embodiment No. 5 of the present invention takes advantage of illuminating at least one rotating three dimensional shape from within the shape. This produces a unique effect, which can appeal to a market driven by the marriage of technology and fun.

### SUMMARY OF THE INVENTION

Embodiment No. 1 of the present invention is a spinning toy that lights up. One embodiment of Embodiment No. 1 can be a hand held spinning toy with an illuminated image comprising a hand held base unit with a housing, a hand grip molded into the housing, an on/off switch, an internal power source, circuitry and wiring, LED lights, a motorized device having a central subsystem spinning about a central axis, a translucent center-molded globe capable of transmitting light, and/or at least one extension element that carries wiring extending from the central axis area to at least one LED light at the far end. The globe can be constructed from at least two molded pieces that snap together, and the globe has at least one sculpted extension to form a three dimensional shape or recognizable image. The sculpting also has a film material internally housed which, when illuminated while spinning has an interesting visual appearance. The extension elements can be flexible or rigid, and they can extend to a maximum radius from a central axis of rotation as the central axis spins. While spinning, transmitted light extends into the sculpting. A sensor can provide a signal with each rotation or part thereof of the globe relative to the housing, and this can enable synchronization of power pulses of varying time and/or intensity with the three dimensional shape and/or recognizable image and/or internal film. There may also be a means to create sounds, which can also be synchronized with spinning and the lighted elements. There may also be a communication device that can receive data and/or signals via at least one of RF, IR, acoustically, and/or other methods.

Embodiment No. 2 of the present invention produces illumination of a central image via the application of a moving source or sources of light relative to the viewer such that the image appears to be holographic or three dimensional, though the illuminating light is incoherent.

One embodiment of Embodiment No. 2 of the present invention can be a hand held spinning toy with an illuminated object and can have a handle with a motor and at least one battery, and a spinning armature head comprising at least one of a rigid backing supported over the central axis of rotation, a mechanical member perpendicular to the axis of rotation, at least one battery, at least one LED, at least one means of switching a voltage, and at least one tubular element attached to the mechanical member and transmitting light from at least one LED. This LED can be a multi-color LED. The tubular element is of unique construction and is a coiled roll of thin plastic sheet forming a cylindrical shape with an inner diameter that can fit against or over the illuminating LED or light source. This coiled roll of thin plastic sheet can have at least 1 coil forming the cylindrical shape, and embodiments can be composed of 30 or more coils of plastic to properly achieve the desired effect. The spinning head can have a centrifugal switch to activate the spinning electronics, but there can also be a mechanical switch, and there can be a circuit to automatically shut off the spinning electronics after a period of time. There can also be a circuit that contains at least one of the following: a microprocessor, an analog circuit, a digital circuit, and a means for switching at least one voltage on and off. There can be multiple tubular elements, each transmitting and radiating light from a different color LED. The circuit can cause at least one LED to turn on continuously and/or on and off in a stroboscopic fashion. The spinning armature head can be removable and/or replaceable with a different spinning armature head, and this can enable logos or images of one license or class of products to only be compatible with logos or images from the same class and incompatible with other classes. The rigid backing can be symmetrical about the vertical axis of rotation. Writing can be applied to this rigid backing, and this writing can be applied on one side of the vertical axis of rotation to produce the most desirable effect. The rigid backing can be made from clear and/or tinted and/or translucent material so as to enable radiation of light from the flat surface when being edge lit. A decal or design or logo can be affixed to the rigid backing. This decal or design or logo can be removable. The mechanical member that can be predominantly perpendicular to the axis of rotation can be rigid to keep the light radiating tubular element or elements rigidly in position, or alternatively, this mechanical member predominantly perpendicular to the axis of rotation can be flexible enough to permit bending during rotation due to centripetal forces generated during rotation, thus allowing the tubular light radiating elements to flex and change position during rotation. The motor can have an element on the shaft that is keyed such that it is only compatible with a class of spinning armature heads and not compatible with other classes of said spinning armature heads. There can also be within the handle at least one LED to illuminate at least one image or logo or two or three dimensional item, and there can also be a crystal or crystal-like object to be illuminated. The rigid backing can also be supported from the spinning armature head via a low friction shaft and/or ball bearing such that when the spinning armature head rotates, the rigid backing can rotate due to loose friction coupling and/or externally applied forces, and this enables the backing and armature head to spin at different rotation rates and with different angular accelerations. The handle can also project an image onto a surface some distance away, and this can employ at least one lens. The above mentioned circuit can generate a gradually increasing frequency of pulses up to a maximum frequency, followed by a gradually decreasing frequency of pulses to some minimum frequency, and then repeating this ramp up and ramp down in frequency to produce an interesting visual effect. There can also be a means for obtaining a signal to permit synchronization of pulses with the rotating spinning armature head and the handle, and there can be a sequence to control a plurality of strobing patterns of light.

Another embodiment of Embodiment No. 2 of the present invention can be non-motorized, and can be a hand held spinning toy with illuminated object comprising of a handle, an armature head free to rotate comprising of a rigid backing supported on the central axis of rotation, a mechanical member perpendicular to the axis of rotation, at least one battery, at least one LED, at least one means of switching a voltage, and at least one tubular element attached to mechanical member and transmitting light from at least one LED. In such embodiment, the armature head can be hand spun.

Embodiment No. 3 of the present invention is a hand held spinning device with an illuminated image that can comprise of a hand held base unit which can have at least one of the following: a housing, at least one on/off switch, an internal power source, circuitry and wiring, and a motorized device or subassembly comprising of at least one central subsystem spinning about a central axis comprising at least one of the following: a center-supported molded cavity capable of transmitting light with at least two sections and/or surfaces, such as a front surface and a rear surface, at least one LED light contained within the center-supported molded cavity, at least one extension element extending from the central axis area that carries wiring to at least one LED light at the far end, and additional circuitry and/or microprocessor or control chip and wiring. The molded cavity can be any of the following: transparent, translucent, colored, plastic, molded, and/or any combination. A single on/off switch can simultaneously control the movement of the entire device including both the spinning of the center supported molded cavity and at least one extension element, and/or the on/off switch can control the turning on and off of both at least one LED light contained within the center-supported molded cavity and at least one extension element extending from the central axis area that carries wiring to at least one LED light at the far end. There can also be a means to conduct power from the internal power source to the central subsystem spinning about a central axis. This means to conduct power can be at least one slip ring comprising at least one conductive element located at a substantially constant radius from the central axis and at least one brush and/or conductive contact making electrical contact with at least one conductive element located at a substantially constant radius from the central axis. The center-supported molded cavity with a front surface and a rear surface, if present, can be constructed of two molded pieces that snap together in place. The two molded pieces can have an insert either applied externally to front surface and/or inserted within cavity created by two molded pieces that attach together in place. The insert can be at least one of the following: a decal, design, logo, image, character, slogan, letters, numbers, icons, photographs, drawings, and/or any combination thereof in either two or three dimensions. The extension element and/or extension elements can be flexible, such as a wire or cable extending to the light. The extension element can extend to a maximum radius from central axis of rotation. The transmitting light can illuminates the insert. There can further comprise a means to create sounds. There can further comprise at least one sensor and/or sensing element, and this can take the form of a break and/or conductivity discontinuity of at least one conductive element located at a substantially constant radius from said central axis. At least one sensor and/or sensing element can be at least one of the following: a conductive element, a non-conductive element, an optical sensor, a magnetic sensor, a switch and/or brush and/or electrical contact and/or means to create an electrical closure. The sensor and/or sensing element can provide a signal with each rotation or part thereof of the central subsystem spinning about a central axis relative to the housing. The sounds can be synchronized with at least one sensor and/or sensing element. At least one LED light contained within the center-supported molded cavity can be synchronized with at least one extension element extending from the central axis area that carries wiring to at least one LED light at the far end. At least one LED light contained within the center-supported molded cavity and/or with at least one extension element extending from the central axis area that carries wiring to at least one LED light at the far end can be synchronized with and/or a result of the signal provided by the sensor and/or sensing element. There can additionally comprise a means to create power pulses of varying time and/or intensity. The power pulses can be synchronized to the signal using circuitry and/or additional circuitry and/or microprocessor or control chip. There can further comprise a communication device that receives data and/or signals via at least one of RF, electromagnetic, microwave, IR, acoustically, electronic, and/or other methods. The data and/or signals can control and/or influence and/or modulate the LEDs and/or lighting of the image and/or sounds. The center-supported molded cavity capable of transmitting light can further comprise at least one lens capable of projecting light to distant points. At least one extension element extending from the central axis area that carries wiring to at least one LED light at the far end can further comprise at least one lens to enable projection of light from at least one LED. At least one lens can project light at a different angle from another lens, and this can enable many spinning lights to project at different angles, and thus project parallel lines or swatches of light at distant locations. The circuit can cause at least one LED to turn on continuously and/or on and off in a stroboscopic fashion. There can further comprise the ability of the handle to project an image onto a surface. The circuit can generate in a stroboscopic fashion a gradually increasing frequency of pulses up to a maximum frequency, followed by a gradually decreasing frequency of pulses to some minimum frequency, and then repeating this ramp up and ramp down in frequency. There can further comprise a sequence to control a plurality of stroboscopic patterns of light. There can also further comprise at least one second switch in the handle that can cause the operating function to change.

One embodiment of Embodiment No. 4 of the present invention is a spinning toy with illuminated object comprising of a handle comprising a switch, a motor, a motor shaft, and at least one battery, a spinning armature comprising a mechanical member located perpendicular or approximately perpendicular to the axis of rotation, at least one light and/or LED, and at least one tubular element attached to the mechanical member and transmitting and radiating light from at least one light and/or LED. Further, there can be a battery compartment, at least one battery, and at least one means of switching a voltage. Power can be delivered to the spinning armature by means of slip rings. The tubular element can be a coiled roll of thin plastic sheet forming a cylindrical shape with an inner diameter that fits against or over a light and/or LED, and this coiled roll of thin plastic sheet can have at least 1 coil forming the cylindrical shape. This particular configuration of a rolled coil produces a desirable and unique optical effect. The tubular element can also be an extrusion forming a cylindrical shape with an inner diameter that fits against or over a light and/or LED. There can be a dome to enclose the spinning armature, and the dome can be illuminated with lights under the dome. The dome can contain a logo and/or image and/or three dimensional object. The handle can also contain a logo and/or image and/or three dimensional object. The logo and/or image and/or three dimensional object can be illuminated, and the object can be a figurine, an image on a flat surface, a image with raised and/or depressed three dimensional features, a logo, and/or a rigid backing located over a central axis of rotation. The rigid backing can have an internal compartment in which a rigid and/or flexible member containing a logo and/or image is inserted. The mechanical member can contain at least one light and/or LED and/or source of light. The illuminated object can be suspended and/or supported from the dome. The illuminated object can either be stationary or can rotate with the spinning armature. The handle can also contain lights. The illuminated object can contain two character images that will appear to be merged via synchronized pulses of light illuminating the characters in an alternate manner such that one character is illuminated by one flash of light and the other character is illuminated by another flash of light. There can be a detachable and removable base stand. There can also be sound. The spinning toy can be in the overall shape of a cone. The handle can contain a lens and a means to project an image. There can be a switch and/or sensor and/or sensing element, any of which can provide a signal with each rotation or part thereof of the spinning armature spinning about a central axis relative to the housing and/or handle. Sounds can be synchronized with the switch and/or sensor and/or sensing element. There can be a means to create power pulses of varying time and/or intensity, and these power pulses can be synchronized to the signal using circuitry. Sound can also be synchronized with the illuminated object. There can also be a communication device that receives data and/or signals via at least one of RF, IR, acoustically, and/or other methods. There can also be RFID technology and/or proximity sensing devices that can produce a proximity signal to indicate proximity to at least one object and/or location, and this can enable custom sounds and/or lighting patterns to indicate proximity to at least one object and/or location. The logo and/or image and/or illuminated object and/or handle can contain an internal logo and/or character printing on the inside. This internal logo and/or character printing can be a light porous paper-like product. This embodiment of the invention can be handheld.

Another embodiment of Embodiment No. 4 of the present invention can be a spinning toy with illuminated image comprising of the following: a base unit having a housing, a hand grip molded into the housing, a means of switching power on and off, a power source, circuitry and wiring, at least one light and/or LED light, and a motorized device having a central subsystem spinning about a central axis, and at least one extension element extending from the central axis area to a light emitting element radially located when in motion. At least one extension element can be flexible or rigid. The extension element can extend to a greater radius from said central axis, particularly when spinning. The extension element or elements can contain wires. The light emitting element can contain at least one light and/or LED light, and this light emitting element radially located can be a diffuser. The diffuser can be a commonly recognizable shape including but not limited to at least one of a star, crystal, sphere, geometric shape, character, rocket, airplane, car, animal, and/or machine. The extension element can also contain at least one fiber optic. The light emitting element can contain at least one frosted section. The fiber optic can be fed with light from and transmitted up through the hand held base unit. There can be a transparent and/or translucent molded shell capable of transmitting light. The transparent and/or translucent molded shell can be constructed of two molded pieces that snap together. The two molded pieces can have a sculpting extending beyond the molded shell above and/or outward to form a three dimensional shape and/or recognizable image. The transparent and/or translucent molded shell can further comprise a film material internally housed. The transparent and/or translucent molded shell capable of transmitting light can have a logo and/or image and/or three dimensional object inserted. There can be lights in the handle. The handle can contain a lens, and there can be projection out of the bottom and/or side of the handle. There can be a removable base. There can be a logo and/or image and/or three dimensional object in the handle, and this logo and/or image and/or three dimensional object can be illuminated. There can also be a means to create sounds. There can be a switch and/or sensor and/or sensing element, and any of these can provide a signal with each rotation or part thereof of the central subsystem spinning about a central axis relative to the housing. Sounds can be synchronized with the switch and/or sensor and/or sensing element. There can be a means to create power pulses of varying time and/or intensity, and these power pulses can be synchronized to the signal using the circuitry. The sound can be synchronized with the illuminated object. There can be a communication device that receives data and/or signals via at least one of RF, IR, acoustically, and/or other methods, and this data and/or signals can control the LEDs and/or lighting of the image and/or the sounds produced. The RFID technology and/or proximity sensing devices that can produce a proximity signal to indicate proximity to at least one object and/or location can cause the creation of custom sounds and/or lighting patterns that can indicate proximity to at least one object and/or location. The molded shell and/or hand held base unit can contain an internal logo and/or character printing on the inside, and this internal logo and/or character printing can be a light porous paper-like product. This embodiment of the invention can be handheld.

Embodiment No. 5 of the present invention is a hand held spinning toy with at least one illuminated object comprising of the following: a hand-held base unit housing, at least one switch or button, at least one power source, circuitry or wiring or circuitry and wiring, a motorized sub-system having: an assembly spinning about a central axis, at least one LED, and at least one shape capable of at least one of transmitting light, reflecting light, or being illuminated by light. The hand held spinning toy can further comprise slip rings to transfer power from the base housing to the spinning portion. At least one switch or button can be an on/off switch or button. At least one switch or button can be a mode control switch or button. The mode control switch or button can change at least one pattern of illumination. At least one pattern of illumination can be six patterns of illumination. At least one pattern of illumination can be at least seven patterns of illumination. At least one pattern of illumination can be at least one of at least one multiplicity of at least one pattern of illumination, a constant static color, at least one color that fades from at least one color to at least one other color, at least one color that abruptly changes from at least one color to at least one other color, multi-color, at least one blinking pattern, and/or at least one dimming pattern. The hand-held base unit housing can also contain at least one LED. At least one shape capable of transmitting light, reflecting light, or being illuminated by light can be at least one of molded, die-cut, die cast, assembled, glued, or consisting of several shapes adhered together. At least one shape capable of transmitting light, reflecting light, being illuminated by light can be at least one three dimensional shape. At least one shape capable of at least one of transmitting light, reflecting light, being illuminated by light can contain at least one of a diffusing material, frosted section, translucent section, different density material, or reflective material. The three dimensional shape can be at least one of a star, crystal, sphere, rod, staff, blade, disk, ball, wand, multi-sided, polyhedron, geometric shape, triangle, quadrilateral, pentagon, hexagon, septagon, octagon, polygon of any number of sides, a commonly recognizable shape including but not limited to a character, logo, symbol, rocket, airplane, car, animal, plant, rock, formation, body part, or machine. The hand held spinning toy can further comprise a sculpting extending outward to form a three dimensional shape or recognizable image. At least one shape can contain at least one logo, image, three dimensional object inserted within, applied to, or attached to. At least one LED can be at least one multi-color LED, red LED, green LED, blue LED, yellow LED, purple LED, white LED, IR LED, UV LED.

The hand held spinning toy can further comprise of at least one additional LED. At least one additional LED can be contained within at least one shape capable of at least one of transmitting light, reflecting light, or being illuminated by light. The hand held spinning toy can further comprise of wires contained within the at least one shape. At least one additional LED can illuminate at least one shape and the perimeter of at least one shape in a fashion to produce the image of a three dimensional solid of revolution when rotating. At least one shape can contain a reflective material. At least one power source can be at least one battery. At least one power source can be internal. The housing can have a hand grip molded into it. The hand held spinning toy can further comprise of a means to create at least one sound. The hand held spinning toy can further comprise at least one of an additional switch, sensor, or sensing element. At least one of an additional switch, sensor, or sensing element can provide at least one signal with each rotation or part thereof of the assembly spinning about a central axis relative to the housing. At least one sound can be synchronized with the signal. At least one pattern of illumination can be synchronized with the signal. At least one sound can be synchronized with at least one pattern of illumination. The hand held spinning toy can further comprise a communication device that receives data or signals via at least one of RF, IR, acoustically, or other methods. The data or signals can control at least one pattern of illumination or sounds or at least one pattern of illumination and sounds. The hand held spinning toy can further comprise RFID technology or proximity sensing devices that can produce a proximity signal to indicate proximity to at least one object and location or object or location. At least one custom sound and at least one pattern of illumination or at least one custom sound or at least one pattern of illumination can indicate proximity to at least one object and location or object or location. The hand held spinning toy can further comprise a removable base. The hand held spinning toy can further comprise at least one light in the housing. The housing can contain at least one lens. There can be projection out of the bottom or side or bottom and side of the housing. The hand held spinning toy can further comprise at least one of a logo, image, or three dimensional object in the housing. At least one logo, image, or three dimensional object can be illuminated. The housing can contain at least one logo or character or character and logo printing on the inside. The internal logo or character or logo and character printing can be a light porous paper-like product.

Embodiment No. 6 of the present invention relate to a spinning toy system. The system may include a number of components, including, but not limited to, a spinning platform, a lighting system, a power source, a motor and/or rotation device, at least two extensions stemming from a spinning platform, and/or a housing unit. The spinning action light-up toy can include an on/off switch. The spinning action light-up toy can include a molded topper, which can be shaped like a character, person and/or animal, and/or can light up. The extensions stemming from a spinning platform can be plastic tubing, wire and/or string. The extensions stemming from a spinning platform can have lighting, circuitry, and/or wiring running through it. The ends of the extensions stemming from a spinning platform can be shaped in certain shapes including but not limited to boxing gloves, and can contain at least one lighting system. The housing unit can serve as a hand grip. The spinning action light-up toy can be a handheld toy. The spinning action light-up toy can include a connected base and/or an attachable and removable base, stand and/or platform. The spinning action light-up toy can include a sound system. The sound system and/or lighting system can be programmed and/or sequenced, and/or be controlled by signal or signaling means, such as radio control, radio frequency, infrared, blu-ray, and/or sonar. The method for use of the spinning action light-up toy can comprise three different scenarios: (1) one User uses one (1) spinning action light-up toy; (2) one User uses at least two (2) spinning action light-up toys; and/or (3) at least two (2) Users each use at least one (1) spinning action light-up toy. If one User is using one (1) spinning action light-up toy, the method of use may include the following steps: the User may take control of one (1) spinning action light-up toy; the User may turn the spinning action light-up toy on; the User may place and/or hold the spinning action light-up toy; the User may enjoy the light show created by the spinning action light-up toy; and the User may turn the spinning action light-up toy off. If one User is using at least two (2) spinning action light-up toys, the method for use may include the following steps: the User may take control of at least two spinning action light-up toys; the User may turn each spinning action light-up toy on; the User may place and/or hold the spinning action light-up toys in close proximity of one another; the User may enjoy the light show and contact sequence created by the spinning action light-up toys; and the User may turn each spinning action light-up toy off. If at least two (2) Users each use at least one (1) spinning action light-up toy, the method of use may include the following steps: each User may take control of at least one (1) spinning action light-up toy; each User may turn his/her respective spinning action light-up toy on; the Users may place and/or hold his/her respective spinning action light-up toy in close proximity to the spinning action light-up toy of the other User(s); each User may enjoy the light show and contact sequence created by the spinning action light-up toys; and each User may turn his/her respective spinning action light-up toy off.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF THE DRAWINGS

FIG. 1 depicts Embodiment No. 1 of the present invention and shows a side view of the invention with the sculpted central rotating figure, the rotating elements, and the handle.

FIG. 2 depicts Embodiment No. 2 of the present invention and shows the handle and back view of the spinning armature with the rigid backing in the shape of a circular logo. The coiled roll of thin plastic sheet forming a cylindrical shape is shown in back of the circular logo.

FIG. 3 depicts Embodiment No. 2 of the present invention and shows the handle and front view of the spinning armature with the rigid backing in the shape of a circular logo. The coiled roll of thin plastic sheet forming a cylindrical shape is shown in front of the circular logo.

FIG. 4 depicts Embodiment No. 2 of the present invention and shows the handle, the spinning armature with the rigid backing in the shape of circular logo, the mechanical member perpendicular to the axis of rotation, and the coiled roll of thin plastic sheet forming a cylindrical shape.

FIG. 5 depicts Embodiment No. 2 of the present invention and shows the spinning armature with a clear round rigid backing with a circular logo attached, the mechanical member perpendicular to the axis of rotation, and two coiled rolls of thin plastic sheet forming two cylindrical shapes, with one capable of illuminating the front of the circular logo and the other capable of illuminating the back of the circular logo.

FIG. 6 depicts Embodiment No. 2 of the present invention and shows a spinning armature with a circular logo symmetrically positioned over the vertical axis of rotation, and also shown is the mechanical member perpendicular to the axis of rotation, and four cylinders, each capable of being illuminated by a different color LED.

FIG. 7 depicts Embodiment No. 2 of the present invention and shows an end view of a partially coiled roll of thin plastic sheet, which generates a unique illumination method.

FIG. 8 depicts Embodiment No. 2 of the present invention and shows an end view of a coiled roll of thin plastic sheet, which generates a unique illumination method.

FIG. 9 depicts Embodiment No. 3 of the present invention and shows the invention revealing a non-rotating handle and a rotating upper sub-assembly from which four flexible illuminated elements extended due to centripetal force created through the action of spinning. Also shown is the rotating translucent disk.

FIG. 10 depicts Embodiment No. 3 of the present invention and shows the invention revealing a non-rotating handle and a rotating upper sub-assembly from which four flexible illuminated elements extended due to centripetal force created through the action of spinning. Also shown are the separated two halves of the rotating translucent disk, thus revealing a vertically oriented circuit board upon which five LEDs are attached.

FIG. 11 depicts Embodiment No. 4 of the present invention and shows centrally located figures illuminated by spinning tubular elements in an open environment.

FIG. 12 depicts Embodiment No. 4 of the present invention and shows centrally located figures illuminated by spinning tubular elements within an enclosed volume.

FIG. 13 depicts Embodiment No. 4 of the present invention and shows where centrally located figures would be suspended from the top and illuminated by spinning tubular elements within an enclosed volume in the shape of a cone.

FIG. 14 depicts Embodiment No. 4 of the present invention and shows figures suspended from the top and illuminated by spinning tubular elements within an enclosed volume in the shape of a cone, with an added projection of images from the bottom of the cone.

FIG. 15 depicts Embodiment No. 4 of the present invention and shows a removable spinning element containing a central element with an image illuminated by multiple tubular elements of light.

FIG. 16 depicts Embodiment No. 4 of the present invention and shows a handle, an illuminated spinning head, and flexible elements that are illuminated at the ends.

FIG. 17 depicts Embodiment No. 4 of the present invention and shows a handle, an illuminated spinning head, and flexible elements that are illuminated at the ends, and there is also projection of light from the bottom of the handle.

FIG. 18 depicts Embodiment No. 4 of the present invention and shows a handle, an illuminated spinning head, and flexible elements that are illuminated at the ends, and there is projection of light from the bottom of the handle, and there is also a removable base that the handle can mount within.

FIG. 19 depicts Embodiment No. 4 of the present invention and shows a handle and a spinning illuminated hollow element in which an image can be inserted.

FIG. 20 depicts Embodiment No. 5 of the present invention and shows one color illuminating one embodiment of a geometric shape

FIG. 21 depicts Embodiment No. 5 of the present invention and shows one color illuminating one embodiment of a geometric shape

FIG. 22 depicts Embodiment No. 5 of the present invention and shows an embodiment of a circular three dimensional shape attached to the geometric shape.

FIG. 23 depicts Embodiment No. 5 of the present invention and shows a top view of an embodiment of a circular three dimensional shape attached to the geometric shape.

FIG. 24 depicts Embodiment No. 6 of the present invention where the extensions are illuminated and the housing unit is shaped like various animals and dinosaurs, and such housing units are at rest.

FIG. 25 depicts Embodiment No. 6 of the present invention where the extensions are illuminated and the housing unit is shaped like various animals and dinosaurs, and such housing units are motion and are engaging in a contact sequence.

FIG. 26 depicts one possible schematic of the design of Embodiment No. 6 of the present invention.

FIG. 27 depicts one possible schematic of the design of Embodiment No. 6 of the present invention.

FIG. 28 depicts one possible schematic of the design of the lighting system of Embodiment No. 6 of the present invention.

### DETAILED DESCRIPTION OF THE DRAWINGS

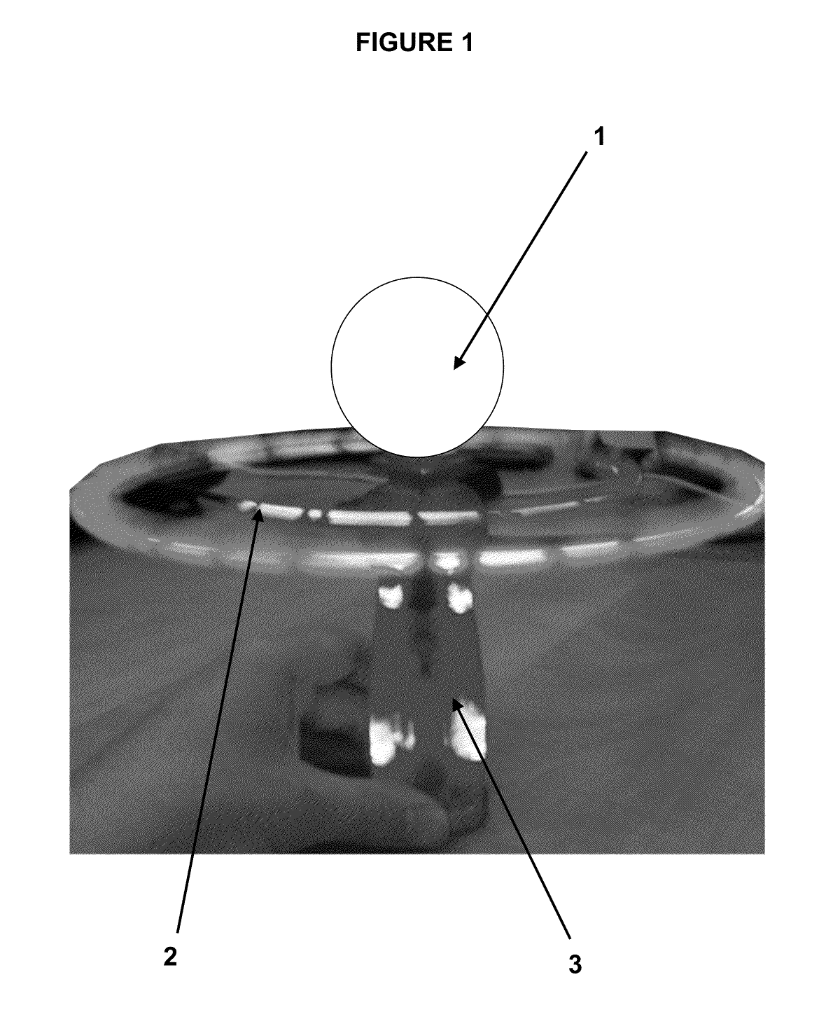

FIG. 1 depicts Embodiment No. 1 of the present invention and shows a side view of the invention with the sculpted central rotating figure, the rotating elements, and the handle.

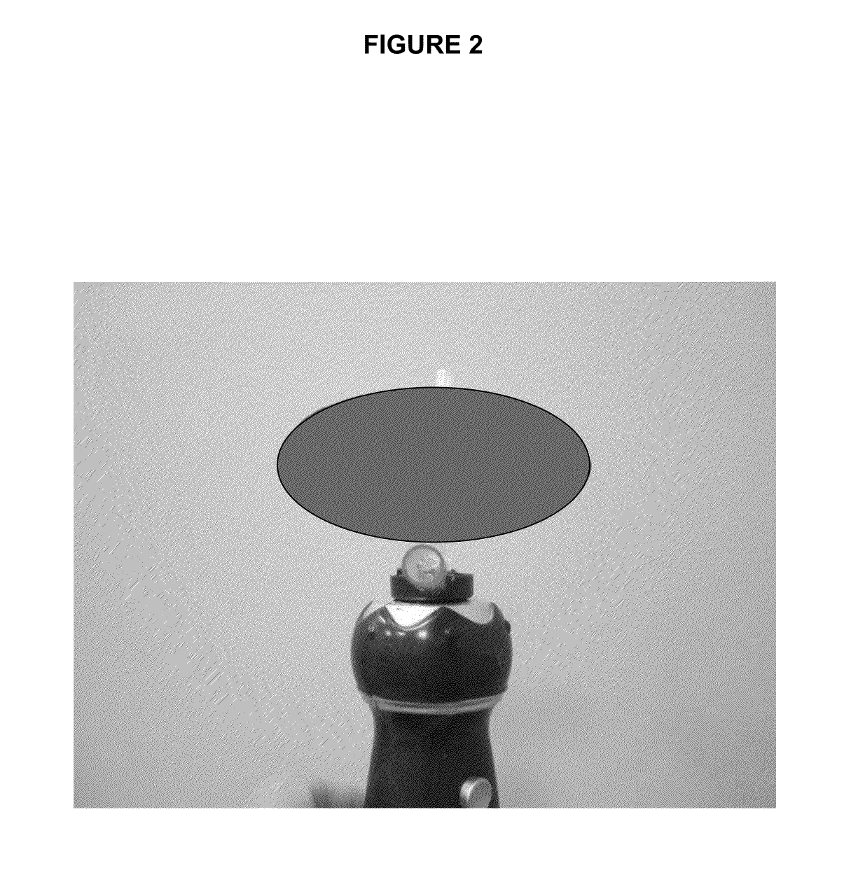

FIG. 2 depicts Embodiment No. 2 of the present invention and shows the handle and back view of the spinning armature with the rigid backing in the shape of a circular logo. The coiled roll of thin plastic sheet forming a cylindrical shape is shown in back of the circular logo.

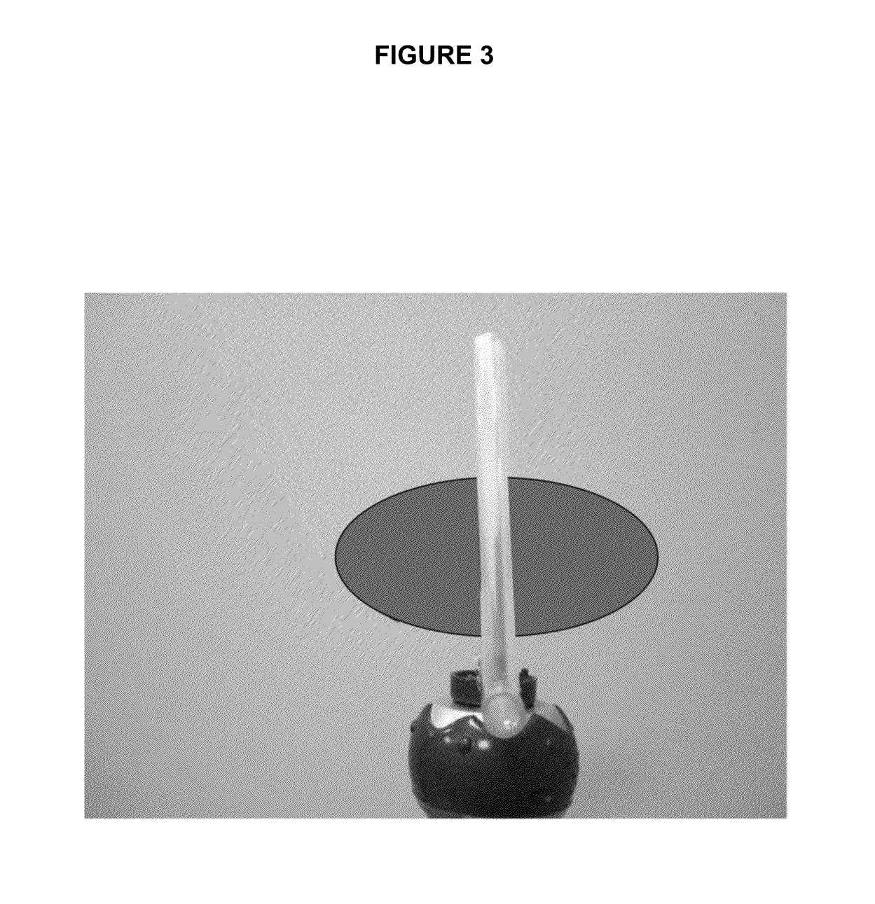

FIG. 3 depicts Embodiment No. 2 of the present invention and shows the handle and front view of the spinning armature with the rigid backing in the shape of a circular logo. The coiled roll of thin plastic sheet forming a cylindrical shape is shown in front of the circular logo.

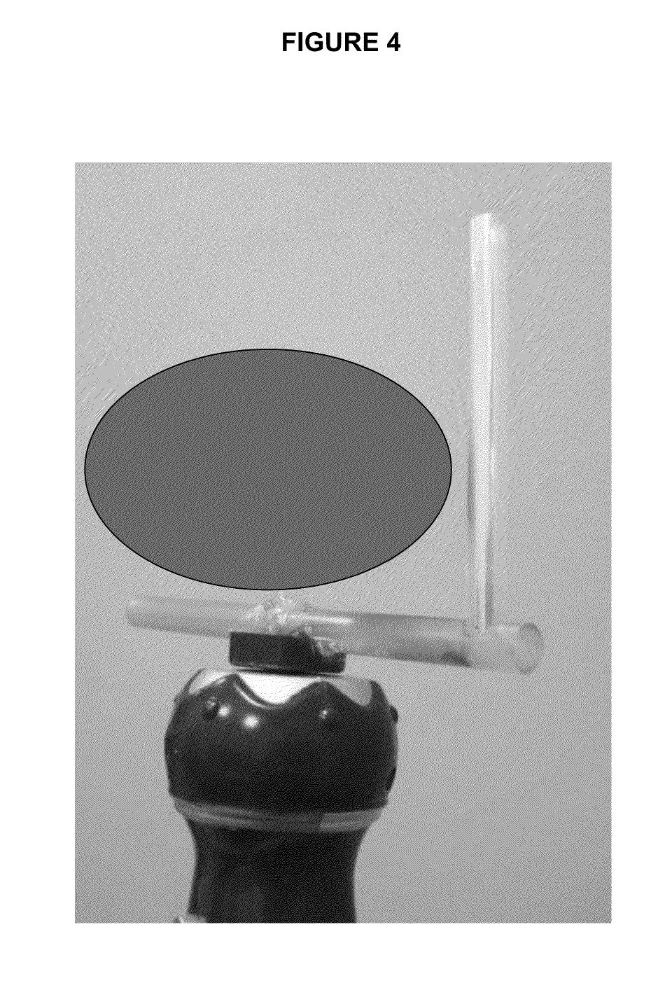

FIG. 4 depicts Embodiment No. 2 of the present invention and shows the handle, the spinning armature with the rigid backing in the shape of circular logo, the mechanical member perpendicular to the axis of rotation, and the coiled roll of thin plastic sheet forming a cylindrical shape.

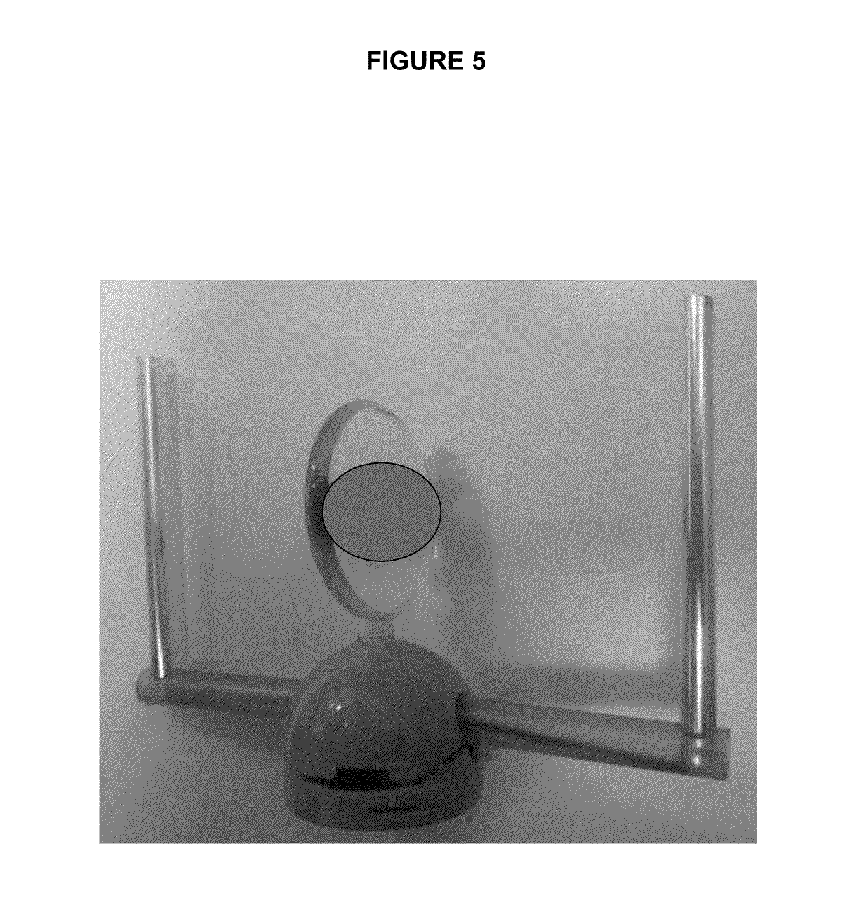

FIG. 5 depicts Embodiment No. 2 of the present invention and shows the spinning armature with a clear round rigid backing with a circular logo attached, the mechanical member perpendicular to the axis of rotation, and two coiled rolls of thin plastic sheet forming two cylindrical shapes, with one capable of illuminating the front of the circular logo and the other capable of illuminating the back of the circular logo.

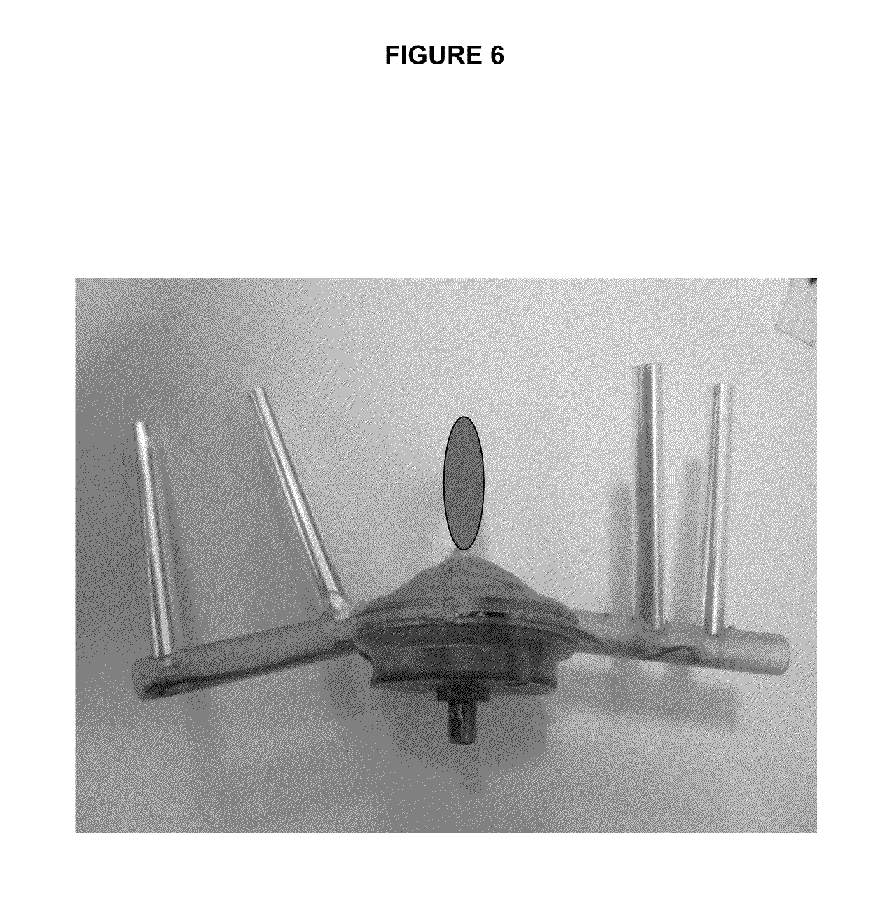

FIG. 6 depicts Embodiment No. 2 of the present invention and shows a spinning armature with a circular logo symmetrically positioned over the vertical axis of rotation, and also shown is the mechanical member perpendicular to the axis of rotation, and four cylinders, each capable of being illuminated by a different color LED.

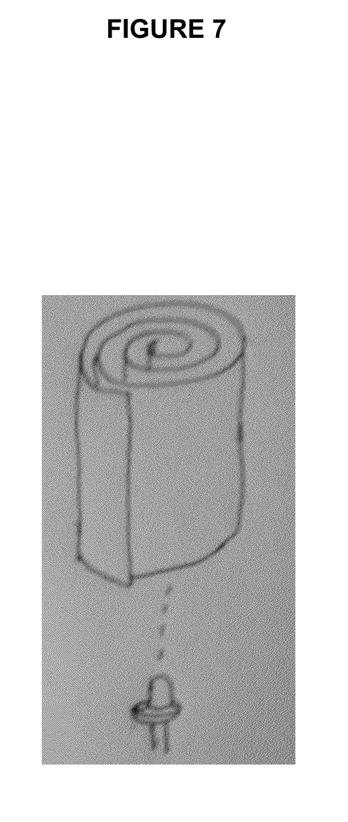

FIG. 7 depicts Embodiment No. 2 of the present invention and shows an end view of a partially coiled roll of thin plastic sheet, which generates a unique illumination method.

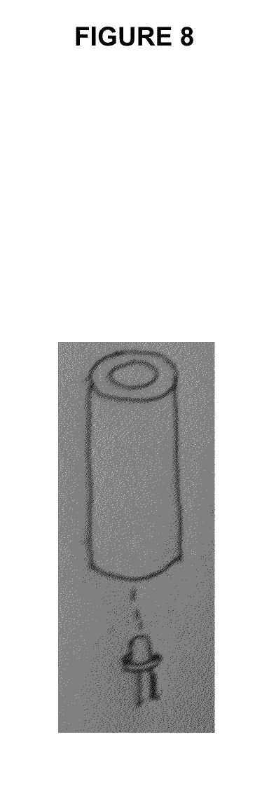

FIG. 8 depicts Embodiment No. 2 of the present invention and shows an end view of a coiled roll of thin plastic sheet, which generates a unique illumination method.

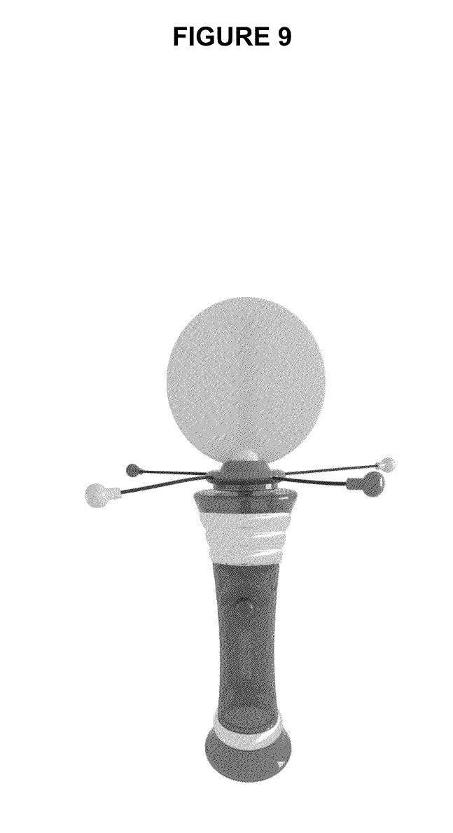

FIG. 9 depicts Embodiment No. 3 of the present invention and shows the invention revealing a non-rotating handle and a rotating upper sub-assembly from which four flexible illuminated elements extended due to centripetal force created through the action of spinning. Also shown is the rotating translucent disk.

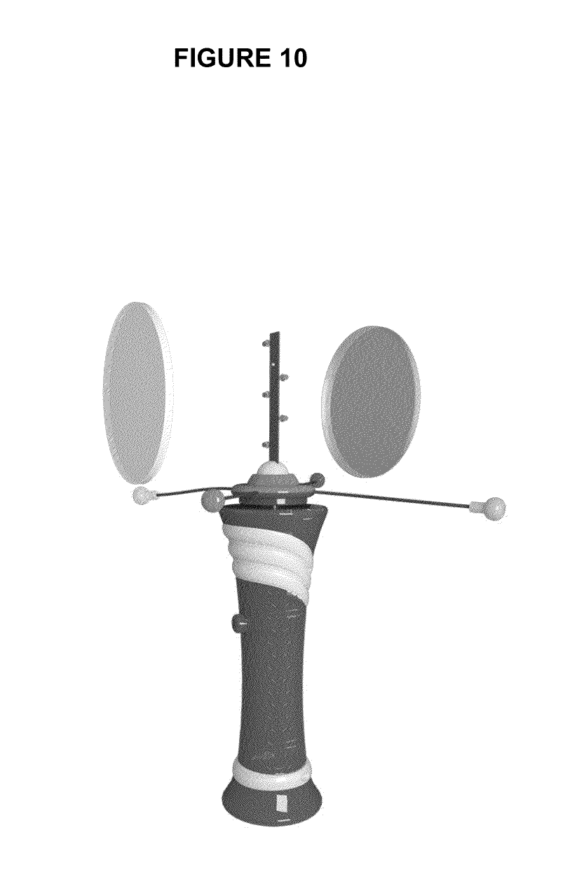

FIG. 10 depicts Embodiment No. 3 of the present invention and shows the invention revealing a non-rotating handle and a rotating upper sub-assembly from which four flexible illuminated elements extended due to centripetal force created through the action of spinning. Also shown are the separated two halves of the rotating translucent disk, thus revealing a vertically oriented circuit board upon which five LEDs are attached.

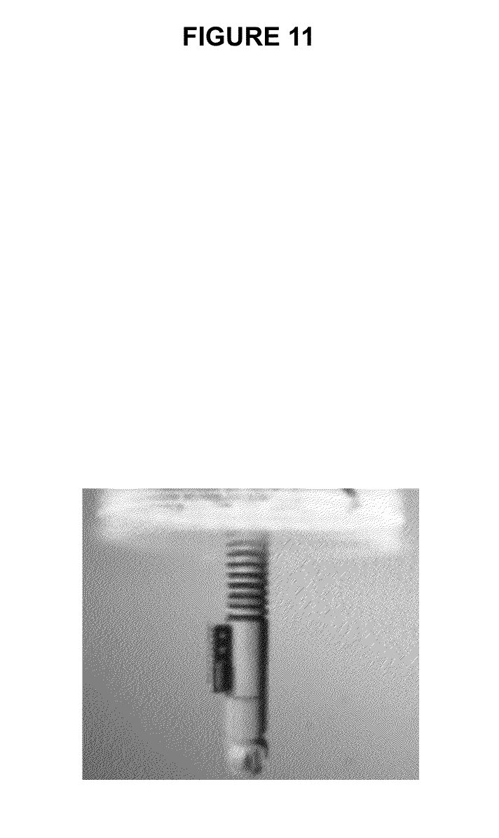

FIG. 11 depicts Embodiment No. 4 of the present invention and shows centrally located figures illuminated by spinning tubular elements in an open environment.

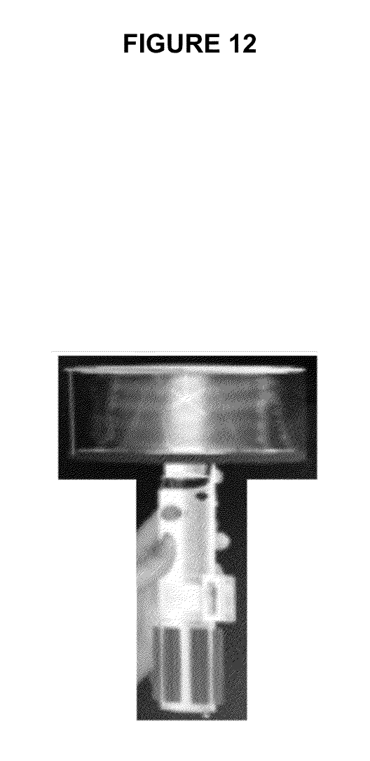

FIG. 12 depicts Embodiment No. 4 of the present invention and shows centrally located figures illuminated by spinning tubular elements within an enclosed volume.

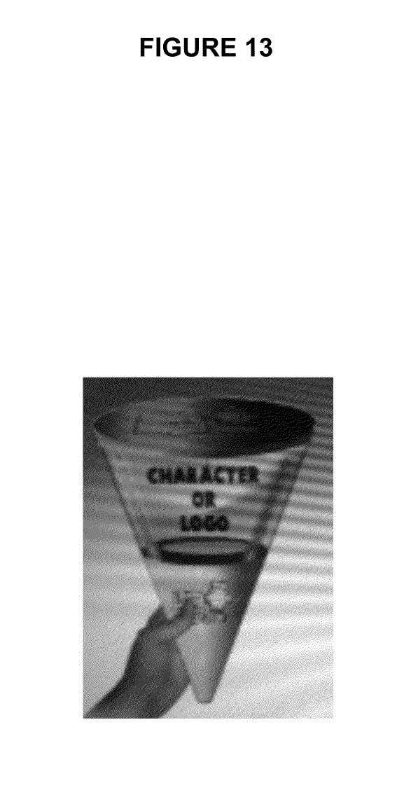

FIG. 13 depicts Embodiment No. 4 of the present invention and shows where centrally located figures would be suspended from the top and illuminated by spinning tubular elements within an enclosed volume in the shape of a cone.

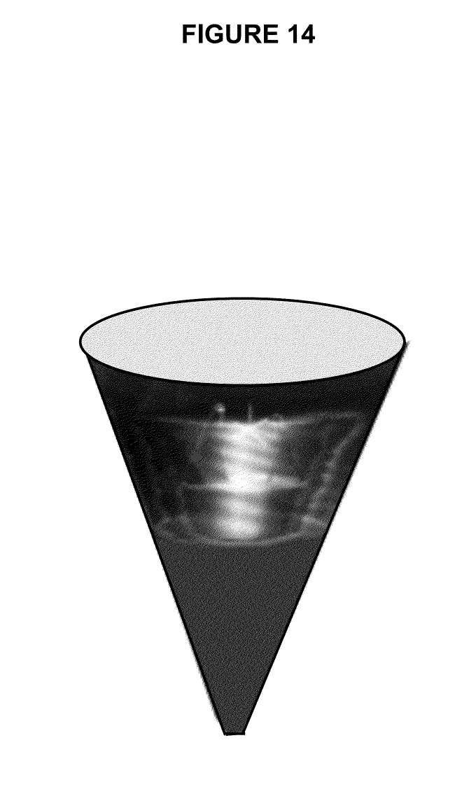

FIG. 14 depicts Embodiment No. 4 of the present invention and shows figures suspended from the top and illuminated by spinning tubular elements within an enclosed volume in the shape of a cone, with an added projection of images from the bottom of the cone.

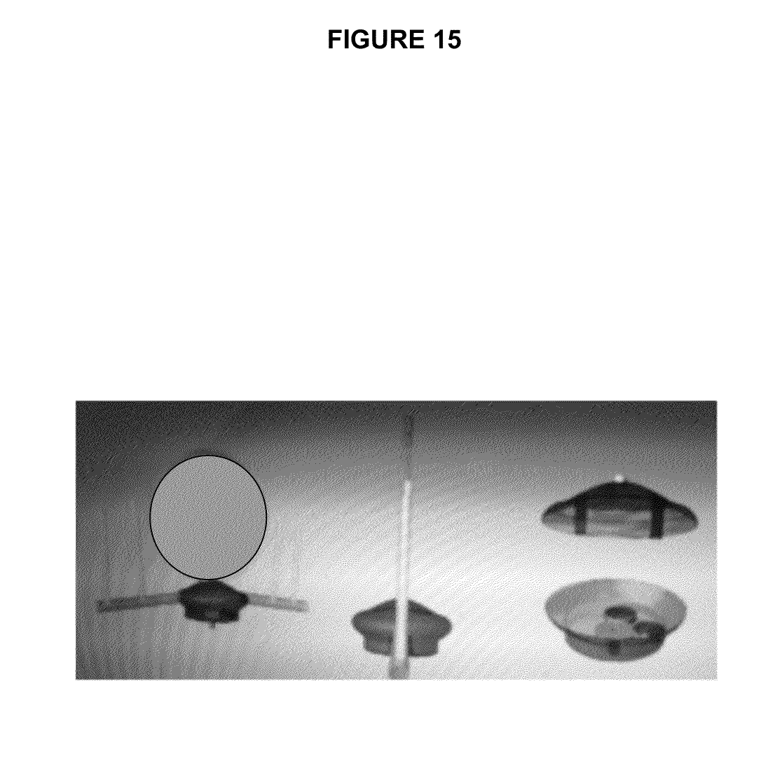

FIG. 15 depicts Embodiment No. 4 of the present invention and shows a removable spinning element containing a central element with an image illuminated by multiple tubular elements of light.

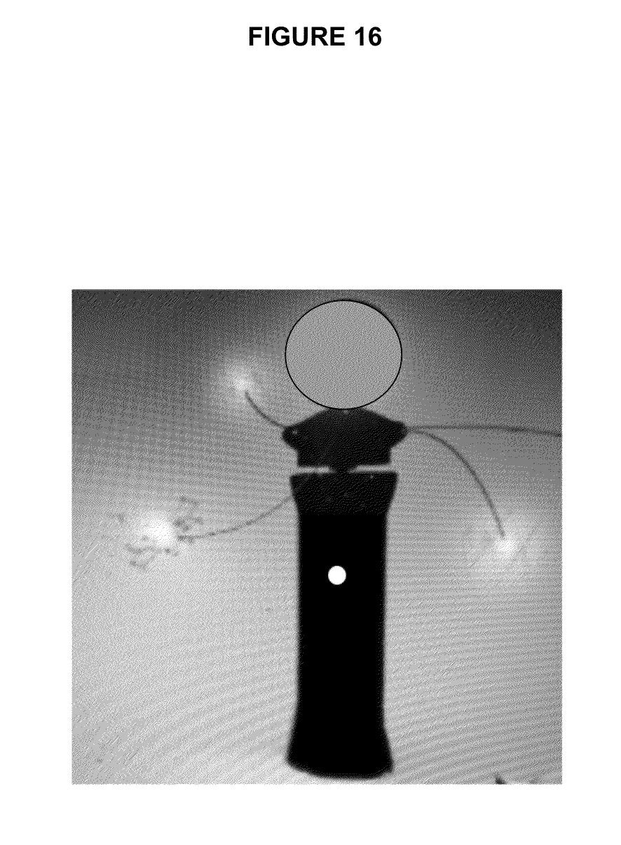

FIG. 16 depicts Embodiment No. 4 of the present invention and shows a handle, an illuminated spinning head, and flexible elements that are illuminated at the ends.

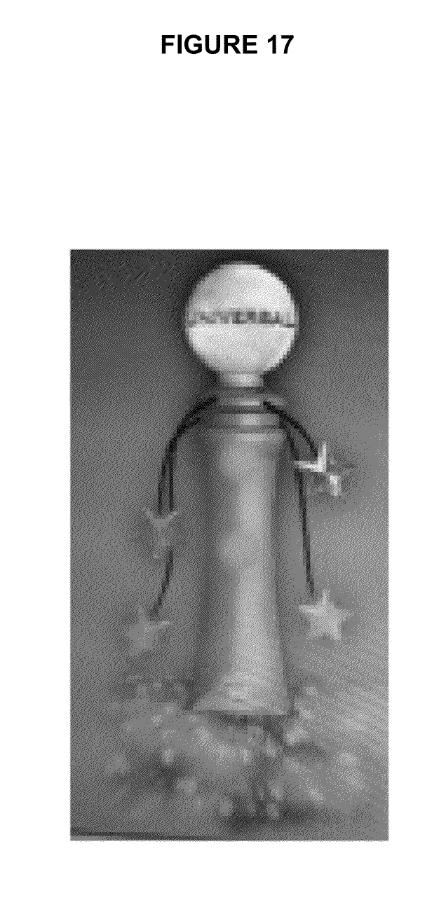

FIG. 17 depicts Embodiment No. 4 of the present invention and shows a handle, an illuminated spinning head, and flexible elements that are illuminated at the ends, and there is also projection of light from the bottom of the handle.

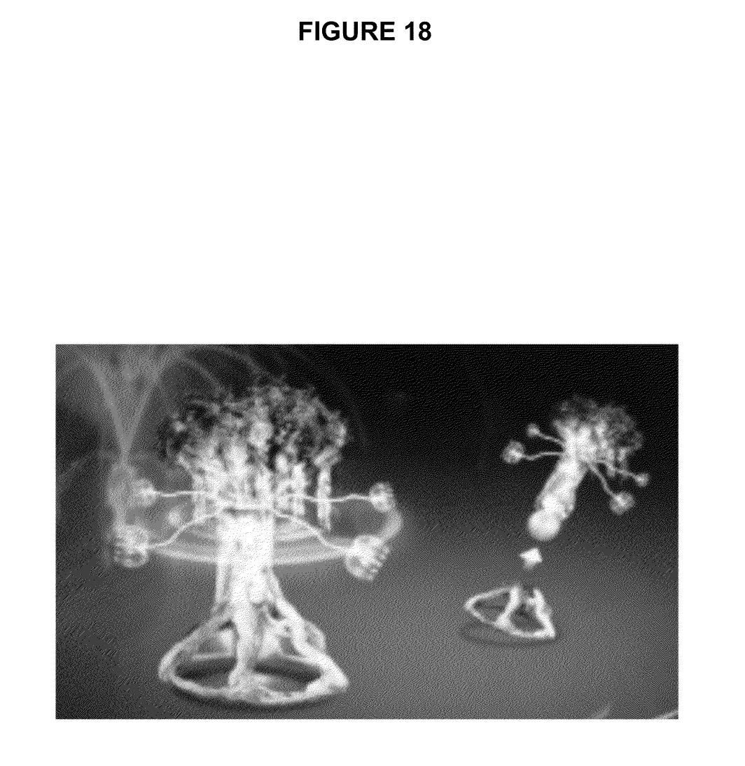

FIG. 18 depicts Embodiment No. 4 of the present invention and shows a handle, an illuminated spinning head, and flexible elements that are illuminated at the ends, and there is projection of light from the bottom of the handle, and there is also a removable base that the handle can mount within.

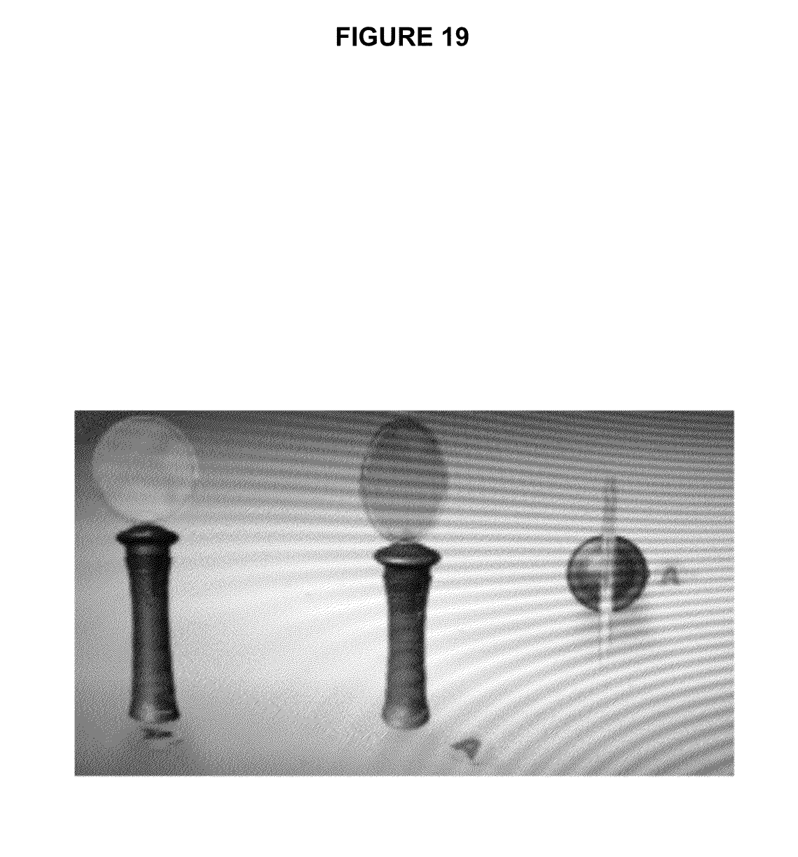

FIG. 19 depicts Embodiment No. 4 of the present invention and shows a handle and a spinning illuminated hollow element in which an image can be inserted.

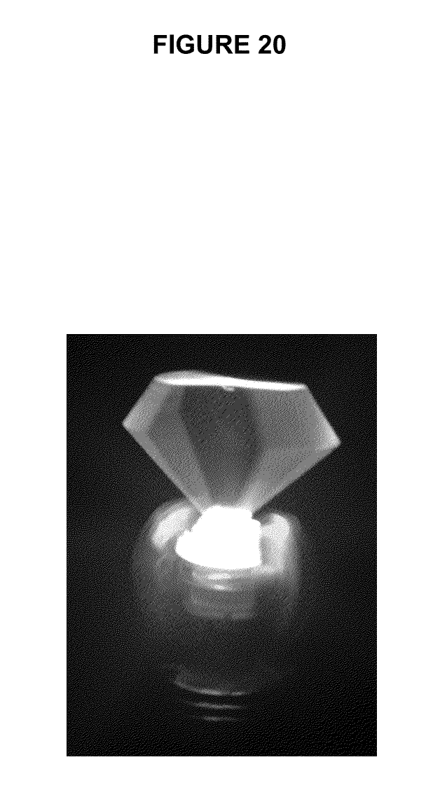

FIG. 20 depicts Embodiment No. 5 of the present invention and shows one color illuminating one embodiment of a geometric shape

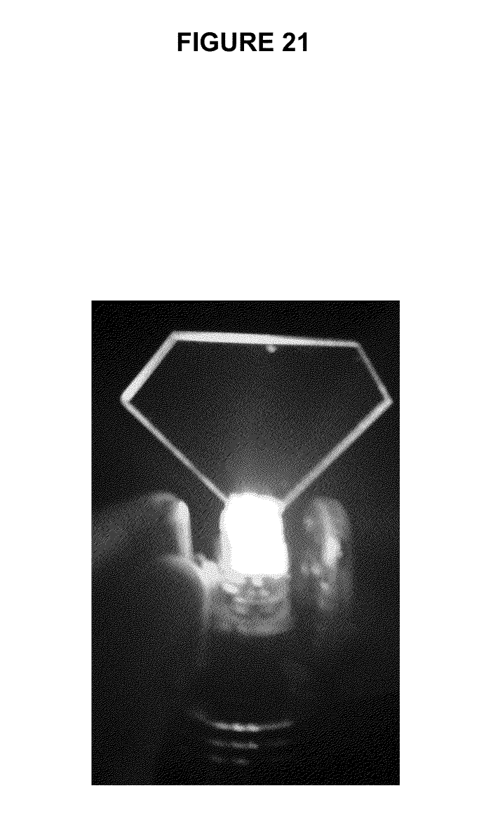

FIG. 21 depicts Embodiment No. 5 of the present invention and shows one color illuminating one embodiment of a geometric shape

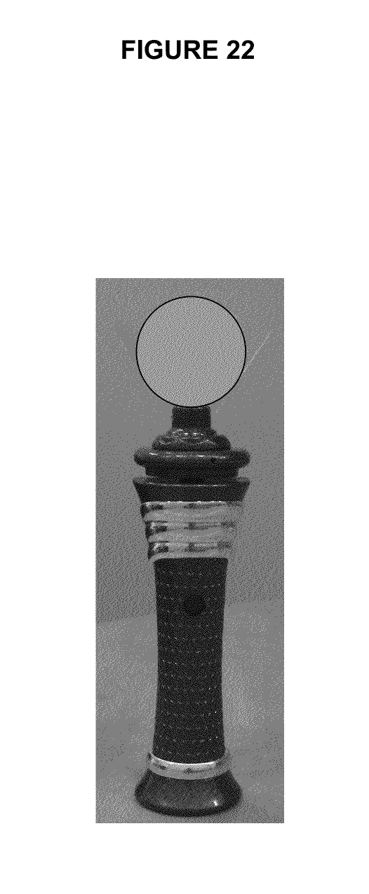

FIG. 22 depicts Embodiment No. 5 of the present invention and shows an embodiment of a circular three dimensional shape attached to the geometric shape.

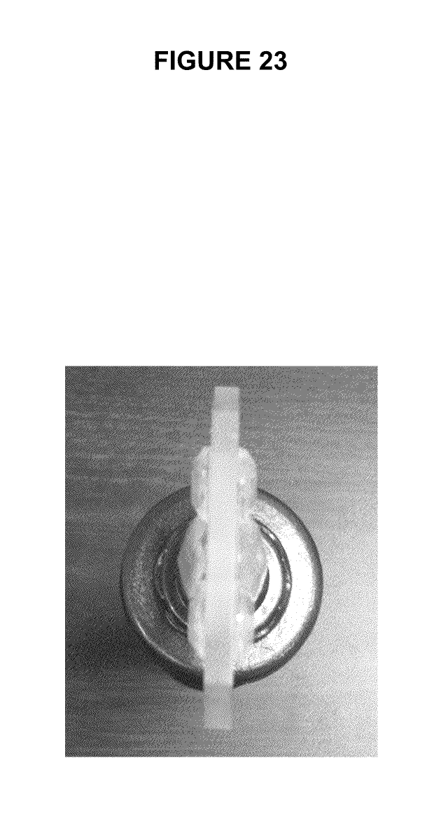

FIG. 23 depicts Embodiment No. 5 of the present invention and shows a top view of an embodiment of a circular three dimensional shape attached to the geometric shape.

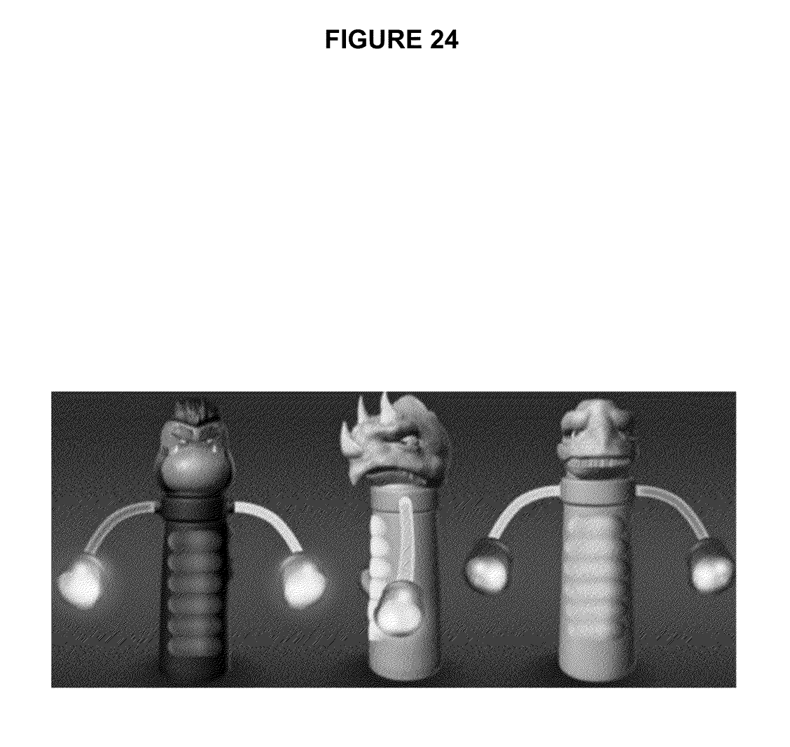

FIG. 24 depicts Embodiment No. 6 of the present invention where the extensions are illuminated and the housing unit is shaped like various animals and dinosaurs, and such housing units are at rest.

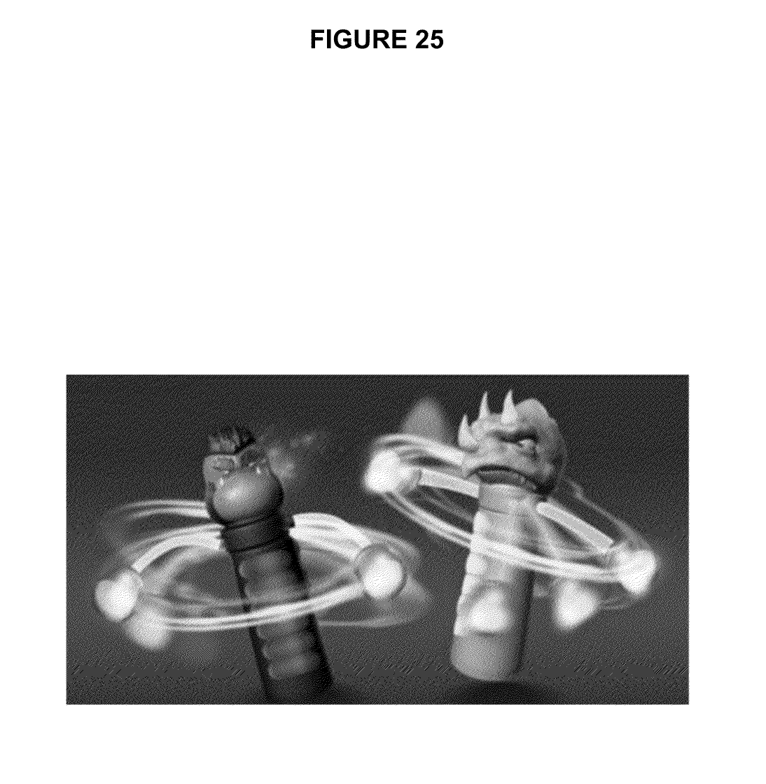

FIG. 25 depicts Embodiment No. 6 of the present invention where the extensions are illuminated and the housing unit is shaped like various animals and dinosaurs, and such housing units are motion and are engaging in a contact sequence.

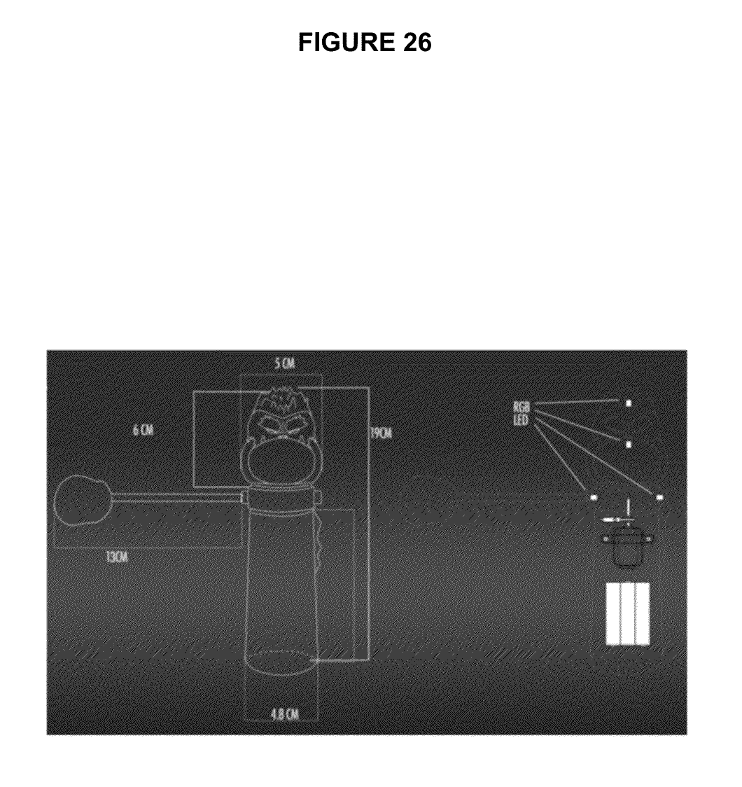

FIG. 26 depicts one possible schematic of the design of Embodiment No. 6 of the present invention.

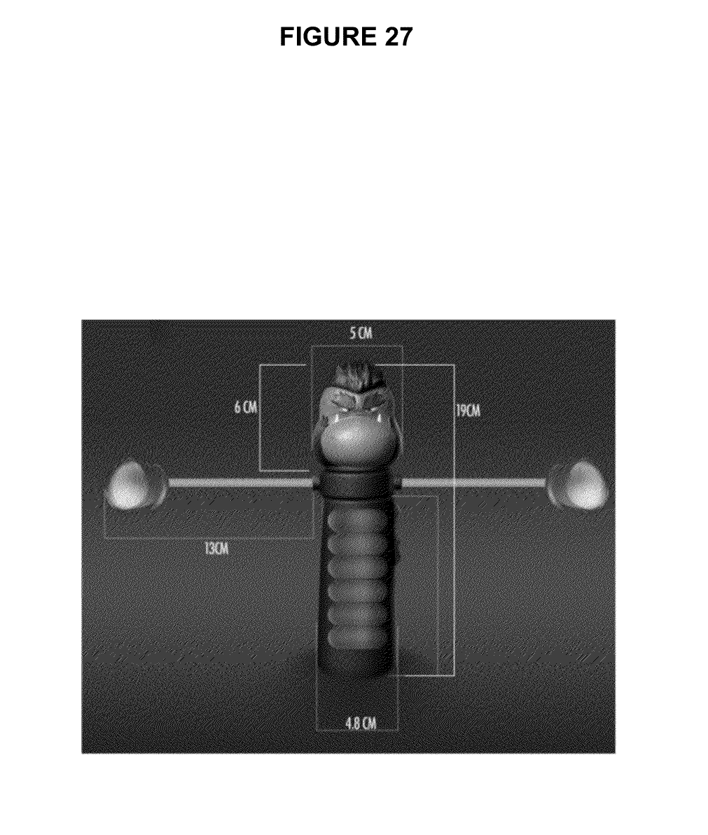

FIG. 27 depicts one possible schematic of the design of Embodiment No. 6 of the present invention.

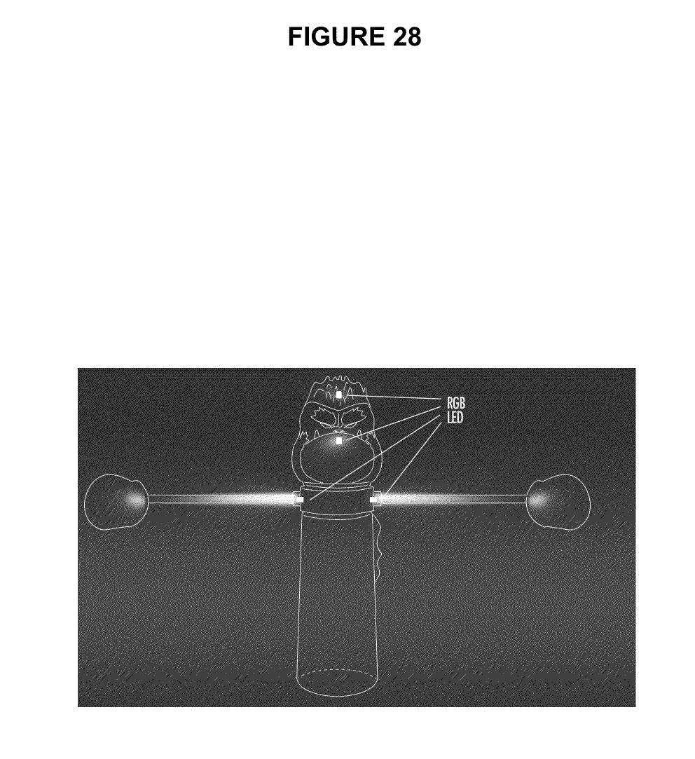

FIG. 28 depicts one possible schematic of the design of the lighting system of Embodiment No. 6 of the present invention.

COMPONENT LIST FOR DRAWINGS

| Component No. | Component Description |
|---|---|
| 1 | Sculpted Central Rotating Figure |
| 2 | Rotating Elements |
| 3 | Handle |

What is claimed:

1. A spinning device comprising at least one of the following:
a lighting system;
at least one of any of the following types of light sources: LED, Multi-color LED, red LED, green LED, blue LED, yellow LED, purple LED, white LED, IR LED, UV LED, fluorescent, incandescent, electroluminescent, laser, IR, visible, UV, chemical, and/or phosphorescent;
at least one lighting system capable of producing at least one pattern of illumination comprising at least one of the following:
turning on continuously at least one color light;
dimming up at least one color light that fades from at least one color light to at least one other color light;
turning on at least one color that abruptly changes from at least one color to at least one other color;
producing multi-colors;
producing at least one blinking pattern;
producing at least one dimming pattern;
turning on and off in at least one stroboscopic pattern;
dimming up and dimming down in at least one stroboscopic pattern;
dimming up at least one rate and dimming down at least one other rate;
generating in a stroboscopic fashion a gradually increasing frequency of pulses up to a maximum frequency followed by a gradually decreasing frequency of pulses to some minimum frequency and then repeating this ramp up and ramp down in frequency;
generating a sequence to control a plurality of stroboscopic patterns of light;
at least one molded cavity or encasing volume, in whole or in part, that is at least one of: transparent, translucent, colored, plastic, frosted, molded;
at least one illuminated object comprising of: at least one of a three dimensional object or shape, a two dimensional object, an image, a shape, a shape containing a reflective material, a logo, figurine, a caricature, an area, a volume, a translucent molded shell, a transparent molded shell, a dome, an illuminated object suspended from said dome, an illuminated object supported from said dome, a cone, globe, a globe constructed of two molded pieces that snap together, a sculpting, a film material housed within said molded shell, an image on a flat surface, a rigid backing located over a central axis of rotation, a decal or design or logo affixed to said rigid backing, a removable decal or design or logo affixed to said rigid backing, a film material, wherein said at least one illuminated object is capable of at least one of transmitting light, reflecting light, refracting light, and/or being illuminated, having a sculpting extending beyond said globe, above, and/or outward to form a 3 dimensional shape and/or image, a sculpting comprising a film material internally housed, transmiting light penetrating a sculpting;
wherein said illuminated object(s) is at least one of: a stand alone said illuminated object(s), or at least one of attached to, applied to, and/or inserted within, in whole or in part, an encasing volume(s) or partial encasing volume(s);
at least one insert that fits within a molded cavity or encasing volume that comprises of at least one of a decal, design, logo, image, character, slogan, letter, number, icon, photograph, drawing, and/or any combination thereof in either two or three dimensions;
at least one object comprising of at least one of a decal, design, logo, image, character, slogan, letter, number, icon, photograph, drawing, and/or any combination thereof in either two or three dimensions;
at least one illuminated object comprising of at least one of a decal, design, logo, image, character, slogan, letter, number, icon, photograph, drawing, and/or any combination thereof in either two or three dimensions;
at least one shape capable of transmitting light, reflecting light, being illuminated by light is at least one of molded, die-cut, die cast, assembled, glued, consisting of several shapes adhered together;
at least one shape capable of at least one of transmitting light, reflecting light, being illuminated by light, contains at least one of diffusing material, frosted section, translucent section, different density material, reflective material;
at least one three dimensional shape that is at least one of a star, crystal, sphere, rod, staff, blade, disk, ball, wand, multi-sided, polyhedron, geometric shape, triangle, quadrilateral, pentagon, hexagon, septagon, octagon, polygon of any number of sides, a commonly recognizable shape including but not limited to a character, logo, symbol, rocket, airplane, car, animal, plant, rock, formation, body part, or machine;
at least one additional LED contained within at least one shape capable of at least one of transmitting light, reflecting light, being illuminated by light;
at least one of an image with at least one of the following:
raised and/or depressed three dimensional features;
a rigid backing located over a central axis of rotation;
a rigid backing located over a central axis of rotation with an internal compartment in which a rigid and/or flexible member containing a logo and/or image is inserted;
an illuminated object that is at least one of a figurine, an image on a flat surface, a image with raised and/or depressed three dimensional features, a logo, a rigid backing located over a central axis of rotation; and/or
an illuminated object containing two character images that will appear to be merged via synchronized pulses of light illuminating the characters in an alternate manner such that one character is illuminated by one flash of light and the other character is illuminated by another flash of light;
at least one of internal power source, external power source, at least one battery,
at least one battery compartment, at least one battery compartment door;
at least one of circuitry, wiring, microprocessor, control chip, LED drivers, analog circuitry, digital circuitry, means of switching voltage, means to create power pulses wiring, means of transmitting a signal;
at least one audio or sound system having at least one of the following: speaker, amplifier, sound synthesizer, sound producing chip, radio, sound or audio file, memory containing audio files or data, digital signal processor, custom sound, MP3 player, and/or recorded sound;
at least one of a switch, button, centrifugal switch, sensor, and/or means of generating a signal;
at least one of said switch, button, centrifugal switch, sensor, means of generating a signal performs at least one of the following functions:
turn power on, turn power off, affect mode control, change at least one mode, change lighting sequences, change lighting patterns, affect dimming, turn audio on, turn audio off, change audio volume, selects audio volume change, synchronization between said lighting and said audio, causes transmission of data, and/or synchronize with each rotation or part thereof of said motorized subsystem spinning about a central axis relative to said housing;
at least one means to automatically shut off power after at least one of a predetermined period of time, a non-predetermined period of time, and/or a period of time functionally dependent upon a variable;
RFID technology and/or proximity sensing devices that will produce a proximity signal to indicate proximity to at least one object and/or location;
a communication device that receives data and/or signals via at least one of RF, IR, acoustically, and/or other methods;
at least one motion sensor and/or motion detector and/or proximity detector;
a base unit having at least one of the following:
at least one housing;
at least one of an attached hand grip, a removeably attached hand grip, a handle, a hand grip molded into said housing;
at least one of at least one light, lens, projection device, logo, image, object, illuminated object, three dimensional illuminated object, at least one LED to illuminate at least one of an image, logo, reflective material, two dimensional object, three dimensional object, crystal or crystal-like object;
projection out of the bottom or side or bottom and side of said hand-held base unit housing;
at least one light in said hand-held base unit housing;
at least one object comprising of at least one of a decal, design, logo, image, character, slogan, letter, number, icon, photograph, drawing, and/or any combination thereof in either two or three dimensions;
at least one illuminated object comprising of at least one of a decal, design, logo, image, character, slogan, letter, number, icon, photograph, drawing, and/or any combination thereof in either two or three dimensions;
at least one internal logo or character or logo and character printing on the inside;
an internal logo or character or logo and character printing on the inside that is a light porous paper-like product;
at least one of a switch, button, sensor, means of generating a signal;
at least one second switch that causes the operating function to change;
at least one of a motor, a motor shaft;
at least one slip ring;
at least one slip ring contact;
a removeably attachable base stand;
at least one transmission source of light;
at least one logo, image, illuminated object, and/or handle that contains an internal logo and/or character printing on the inside; and/or
at least one internal logo and/or character printing that is a light porous paper-like product;
a motorized subsystem having at least one of the following:
a spinning platform;
a spinning platform containing at least one motor;
an assembly spinning about a central axis;
an assembly spinning about a central axis and a sub-assembly spinning about a spinning axis;
at least one slip ring;
at least one slip ring contact;
at least one of any of the following types of light sources: LED, Multi-color LED, red LED, green LED, blue LED, yellow LED, purple LED, white LED, IR LED, UV LED, fluorescent, incandescent, electro luminescent, laser, IR, visible, UV, chemical, and/or phosphorescent;
at least one flexible extension element extending from the central axis area that carries light to at least one light-emitting element or object;
at least one rigid extension element extending from the central axis area that carries light to at least one light-emitting element or object;
at least one flexible extension element that extends while spinning to a greater radius from said central axis;
at least one rigid extension element that extends while spinning to a greater radius from said central axis;
at least one flexible extension element that contains at least one wire providing power to at least one light source;
at least one rigid extension element that contains at least one wire providing power to at least one light source;
at least one tubular element attached to said extension element and transmitting and radiating light from at least one LED;
at least one light emitting element that contains at least one light radially located;
at least one light emitting element that contains at least one of a diffuser, a frosted section, a reflecting section, a lens, a recognizable shape, a geometric shape, a shape that is at least one of including but not limited to a star, crystal, sphere, geometric shape, character, rocket, airplane, car, animal, and/or machine;
at least one additional LED contained within at least one shape capable of at least one of transmitting light, reflecting light, being illuminated by light;
at least one additional LED that illuminates at least one shape and perimeter of at least one shape in a fashion to produce the image of a three dimensional solid of revolution;
at least one sensor;
at least one switch;
at least one means of generating a signal;
at least one means to synchronize at least one lighting pattern and/or at least one sound with each rotation or part thereof of said motorized subsystem spinning about a central axis relative to said housing;
at least one fiber optic element;
at least one light pipe;
additional circuitry comprising at least one of a microprocessor, control chip, LED drivers, analog circuitry, digital circuitry, means of switching voltage, means to create power pulses;
at least one mechanical support member extending radially outward from said central axis;
at least one tubular, extension, and/or three dimensionally shaped element attached to said at least one mechanical support member and transmitting or radiating or transmitting and radiating light from said at least one tubular extension, and/or three dimensionally shaped element;
at least one tubular element that is a plurality of tubular elements, each transmitting and radiating light from a either different or the same color LED;
a translucent element capable of transmitting light;
a center-supported cavity capable of transmitting light;
at least one light receiving element to receive light from said at least one transmission source of light; and/or
an edge-lightable rigid backing that is at least one of clear, tinted, translucent, frosted, reflective material, possesses a rough surface, possesses a scored surface;
at least one removeably attached spinning armature head comprising of at least one of the following:
a rigid backing located over a central axis of rotation;
a rigid backing that is symmetrical about a vertical axis of rotation;
a rigid backing upon which writing is applied, and this writing is only on one side of a vertical axis of rotation;
at least one mechanical support member extending radially outward from said central axis of rotation;
a battery compartment;
at least one battery;
a battery compartment door;
at least one light source;
additional circuitry comprising at least one of a microprocessor, control chip, LED drivers, means of switching voltage;
at least one tubular element attached to said at least one mechanical support member and transmitting or radiating or transmitting and radiating light from said at least one tubular element;
an illuminated object that is either stationary or rotates with said spinning armature;
at least one tubular element that is at least one coiled roll of thin plastic sheet forming a cylindrical shape of at least one layer of said thin plastic sheet with an inner diameter that fits against or over a light source;
at least one tubular element that is an extrusion forming a cylindrical shape with an inner diameter that fits against or over at least one light source;
at least one additional LED contained within at least one shape capable of at least one of transmitting light, reflecting light, being illuminated by light; and/or
at least one removeably attached spinning armature head that has an element on the shaft that is keyed such that it is only compatible with a class of said removably attached spinning armature heads and not compatible with other classes of said removably attached spinning armature heads.
